(19) United States
(12) Patent Application Publication
(10) Pub. No.: US 2005/0068649 A1
(43) Pub. Date: Mar. 31, 2005

(54) Optical add/drop structures

(76) Inventors: Chang-Joon Chae, Victoria (AU); An Vu Tran, Victoria (AU); Rodney Tucker, Victoria (AU); Wen De Zhong, Singapore (SG)

Correspondence Address: Blakely Sokoloff;Taylor & Zafman, Seventh Floor, 12400 Wilshire Boulevard, Los Angeles, CA, 90025, US

(21) Appl. No.: 10/482,671

(22) PCT Filed: Jul. 4, 2002
(86) PCT No.: PCT/AU02/00882

(30) Foreign Application Priority Data
Jul. 6, 2001 (AU) PR 6221

(51) Int. Cl. G02B 5/22

(52) U.S. Cl. 359/885

(57) ABSTRACT

An optical drop structure comprising a multi-port optical circulator (MOC), a first reflection filter unit optically connected in series between a first port and a second port of the MOC, a second reflection filter unit optically connected in series between a third port and a fourth port of the MOC, and the optical drop structure is arranged, in use, in a manner such that, a first optical signal entering through a fifth port of the MOC is subjected to the first reflection filter unit and exits at a sixth port of the MOC and a reflected portion of the first optical signal exits at a seventh port of the MOC, and a second optical signal entering through the sixth port of the MOC is subjected to the second reflection filter unit and exits at the fifth port of the MOC and a reflected portion of the second optical signal exits at an eights port of the MOC.

### FIELD OF THE INVENTION

The present invention relates broadly to an add/drop structures for use in e.g. single-fibre bi-directional wavelength division multiplexing (WDM) ring networks.

### BACKGROUND OF THE INVENTION

There is a trend in the design of bi-directional WDM ring networks that optical signals travel along single-fibre connections in both directions. Typically, different groups of wavelengths propagate in opposite directions. The allocation of propagation directions to individual wavelengths may e.g. be interleaved in the spectral domain, i.e. adjacent wavelengths within the spectral domain propagate in opposite directions, resulting in symmetric traffic conditions.

Bi-directional optical add/drop structures may be implemented with an N×N array waveguide grating in-line in the single fibre bi-directional link. However, such adding/dropping of wavelengths in a bi-directional mode can have the disadvantage of increased likelihood of cross talk between the different channels, i.e. wavelength signals, as the adding/dropping is performed on the bi-directional optical signal covering the entire bandwidth used on the single-fibre connection.

In at least preferred embodiments, the present invention seeks to provide an optical add/drop structure with reduced likelihood of cross talk between the different channels.

### SUMMARY OF THE INVENTION

In the summary of invention and the claims components of the same name have been identified as e.g. “first”, “second”, “third” etc. This is intended to mean “first identified”, “second identified”, “third identified” etc. rather than being intended to define a total number of the same components in individual embodiments of the invention. For example, where an embodiment is defined with MOCs having a first, a second and a fifth port, this does not define that there must be a third and a fourth port. In other words, in such an embodiment each MOC has at least 3 ports.

In accordance with a first aspect of the present invention, there is provided an optical drop structure comprising:
a multi-port optical circulator (MOC);
a first reflection filter unit optically connected in series between a first port and a second port of the MOC,
a second reflection filter unit optically connected in series between a third port and a fourth port of the MOC,
and the optical add/drop structure is arranged, in use, in a manner such that:
a first optical signal entering through a fifth port of the MOC is subjected to the first reflection filter unit and exits at a sixth port of the MOC and a reflected portion of the first optical signal exits at a seventh port of the MOC, and
a second optical signal entering through the sixth port of the MOC is subjected to the second reflection filter unit and exits at the fifth port of the MOC and a reflected portion of the second optical signal exits at an eights port of the MOC.

Accordingly, the present invention can provide a bi-directional optical drop structure with reduced likelihood of crosstalk between different channels by implementing the dropping filtering in a uni-directional mode.

Preferably, the optical drop structure is arranged, in use, in a manner such that a third optical signal entering at an ninth port of the MOC is added to the first optical signal prior to the first optical signal exiting the MOC, and such that a fourth optical signal entering at a tenth port of the MOC is added to the second optical signal prior to the second optical signal exiting the MOC.

In one embodiment, the optical drop structure is arranged, in use, such that the third and fourth optical signals are reflected at the first and the second reflection filter units respectively for being added to the first and second optical signals respectively.

Accordingly, the present invention can provide a bi-directional optical add/drop structure with reduced likelihood of crosstalk between different channels by implementing the adding/dropping filtering in a uni-directional mode.

Advantageously, the optical drop structure further comprises:
third and fourth reflection filter units optically connected to an eleventh port and a twelfth port of the MOC respectively, and
wherein the optical drop structure is arranged, in use, in a manner such that:
the first optical signal is filtered at the third reflection filter unit prior to exiting the MOC, and
the second optical signal is filtered at the fourth reflection filter unit prior to exiting the MOC.

Preferably, the optical drop structure further comprises a bi-directional amplifier structure disposed in series between a thirteenth port and a fourteenth port of the MOC, and the optical drop structure is arranged, in use, in a manner such that the first and second optical signals are amplified in a bi-directional amplifier structure prior to exiting the MOC.

In one embodiment, the amplifier unit comprises a gain medium or a semiconductor amplifier or a Raman amplifier. The amplifier unit may comprise a gain medium, the amplifier structure comprises at least one pump laser coupled to the gain medium. The pump laser may be coupled to the gain medium via a wavelength coupler. The gain medium may comprise an active optical fibre or an active planar waveguide. The active optical fibre may comprise Erbium-doped fibre or rare earth doped fibre.

Advantageously, the optical drop structure is arranged, in use, in a manner such that the first and second optical signals are subjected to the first and second reflection filter units prior to being subjected to the first and second reflection filter units respectively.

Preferably, the optical drop structure is arranged, in use, in a manner such that the first and second optical signals are amplified prior to or after being filtered at the third and fourth reflection filter units respectively. In such an embodiment, the optical drop structure may further comprise:
fifth and sixth reflection filter units optically connected to a fifteenth port and a sixteenth port of the MOC respectively, and
wherein the optical drop structure is arranged, in use, in a manner such that the first and second amplified signals are filtered at the fifth and sixth reflection filter units respectively, prior to exiting the MOC.

In one embodiment, the optical structure is implemented with two MOCs interconnected in series. The two MOCs may have opposite circulation directions.

Advantageously, any one or all of the reflection filter units comprises a fibre Bragg grating structure or a Fabry-Perot filter.

In accordance with a second aspect of the present invention, there is provided an optical add structure comprising:
a multi-port optical circulator (MOC);
a first reflection filter unit optically connected in series between a first port and a second port of the MOC,
a second reflection filter unit optically connected in series between a third port and a fourth port of the MOC,
and the optical add/drop structure is arranged, in use, in a manner such that:
a first optical signal entering through a fifth port of the MOC is subjected to the first reflection filter unit and exits at a sixth port of the MOC,
a second optical signal entering through the sixth port of the MOC is subjected to the second reflection filter unit and exits at the fifth port of the MOC,
a third optical signal entering at a seventh port of the MOC is reflected at the first reflection filter unit and exits at the sixth port of the MOC for adding to the first optical signal, and
a fourth optical signal entering at an eighth port of the MOC is reflected at the second reflection filter unit and exits at the fifth port of the MOC for adding to the second optical signal.

In accordance with a third aspect of the present invention there is provided a method of adding/dropping signal portions from a bi-directional optical transmission path, the method comprising the steps of utilising at least one MOC to distinguish between first and second optical signals having opposite transmission directions on the transmission path, subjecting the first and second optical signals to first and second filtering units for adding/dropping said signal portions in a uni-directional mode, and utilising said at least one MOC to direct the first and second signal portions for continued propagation along the transmission path in their respective transmission directions.

### BRIEF DESCRIPTION OF THE DRAWINGS

FIG. 1 is a schematic drawing of a bi-directional optical add/drop structure embodying the present invention;

FIG. 2 is a schematic drawing of a bi-directional optical add/drop structure, with amplification, embodying the present invention;

FIG. 3 is a schematic drawing of a bi-directional optical add/drop structure, with amplification, embodying the present invention.

### DETAILED DESCRIPTION OF THE EMBODIMENTS

Preferred embodiments described provide a bi-directional optical add/drop structure with reduced likelihood of cross talk between different channels by implementing the adding/dropping filtering in a uni-directional mode.

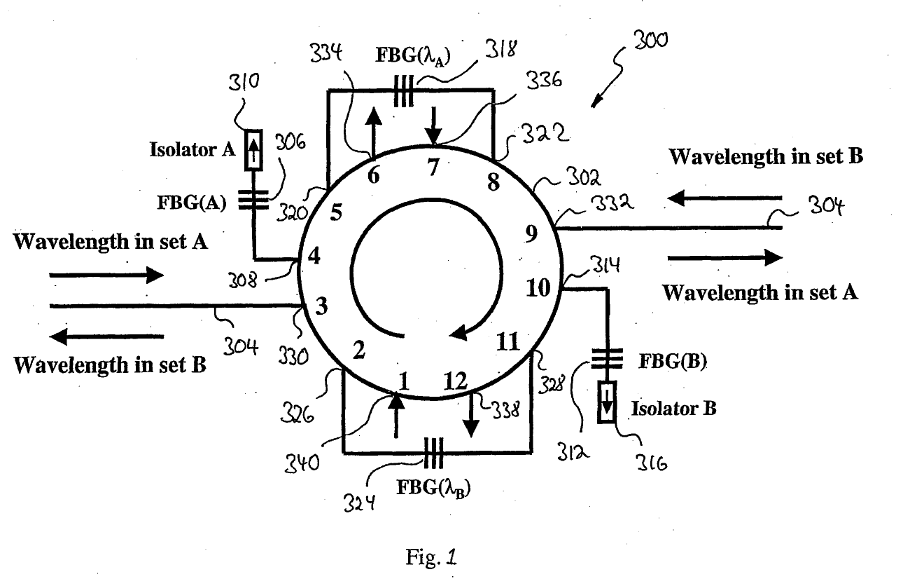

FIG. 1 shows a bi-directional optical add/drop structure 300 embodying the present invention. The add/drop structure 300 comprises a 12 port MOC 302 connected in line with a bi-directional single fibre connection 304. A fibre Bragg grating 306 is connected to port 308 of the MOC 302 in series with an optical isolator 310. Another fibre Bragg grating 312 is connected to port 314 of MOC 302 in series with another optical isolator 316.

Yet another fibre Bragg grating 318 is connected in series between ports 320 and 322 of MOC 302, and a further fibre Bragg grating 324 is connected in series between ports 326 and 328 of MOC 302.

A bi-directional optical signal is travelling along the single-fibre connection 304, with certain wavelengths in a set of wavelengths A and wavelengths in a set of wavelengths B travelling in opposing directions. In the following, it will be described how optical signals travel through the bi-directional add/drop structure 300 in each direction.

An optical signal entering the MOC 302 at port 330 is initially filtered at fibre Bragg grating 306. The fibre Bragg grating 306 is designed such that only the particular wavelengths intended for propagation in that propagation direction are reflected back into the MOC 302, whilst unwanted signal is transmitted. Re-entering of the removed signal as a result of e.g. reflection events is inhibited by isolator 310.

The filtered signal then exits at port 320 and is filtered at the fibre Bragg grating 318. Light that is not reflected at the fibre Bragg grating 318 re-enters the MOC 302 at port 322 and exits at port 332 for continued propagation along the bi-directional single-fibre connection 304.

A particular wavelength that is being reflected at the fibre Bragg grating 318 depending on the design of that fibre Bragg grating 318 re-enters the MOC 302 at port 320 and subsequently exits at port 334. In other words, that particular wavelength is dropped from the optical signal.

At the same time, an optical signal of the same wavelength(s) that is/are dropped at port 334 may enter at port 336 of MOC 302. That signal will exit at port 322, however, it will be reflected by the fibre Bragg grating 318 designed for that particular wavelength(s) (see above), thus re-entering MOC 302 at port 322. Effectively, the additional signal is thus added to the optical signal and exits the MOC 302 through port 332 for continued propagation along the bi-directional single-fibre connection 304.

Similarly, an optical signal entering the MOC 302 at port 332 is filtered at fibre Bragg grating 312 designed to reflect only the particular wavelengths intended for propagation in that particular direction. Unwanted optical signals are transmitted and re-entering into the MOC 302 as a result of e.g. reflection events is inhibited by isolator 316.

The filtered signal exits at port 328 and is filtered at fibre Bragg grating 324. The portion of the signal that is not reflected at the fibre Bragg grating 324 re-enters the MOC 302 at port 326 and exits at port 330 for continued propagation along the bi-directional single-fibre connection 304.

At the same time, a portion of the optical signal i.e. a particular wavelength reflected by the fibre Bragg grating 324 re-enters the MOC 302 at port 328 and subsequently exits at port 338. Thus, that particular wavelength has been dropped from the optical signal.

An optical signal of the same wavelength(s) may enter the MOC 302 at port 340. That signal exits at port 326 but is reflected at fibre Bragg grating 324, which has been designed at that particular wavelength(s) which are dropped at port 338 (see above). The reflected signal thus re-enters at port 326 and is effectively combined with the remainder of the optical signal which is transmitted through the fibre Bragg grating 324, and exits the MOC 302 at port 330 for continued propagation along the bi-directional single-fibre connection 304.

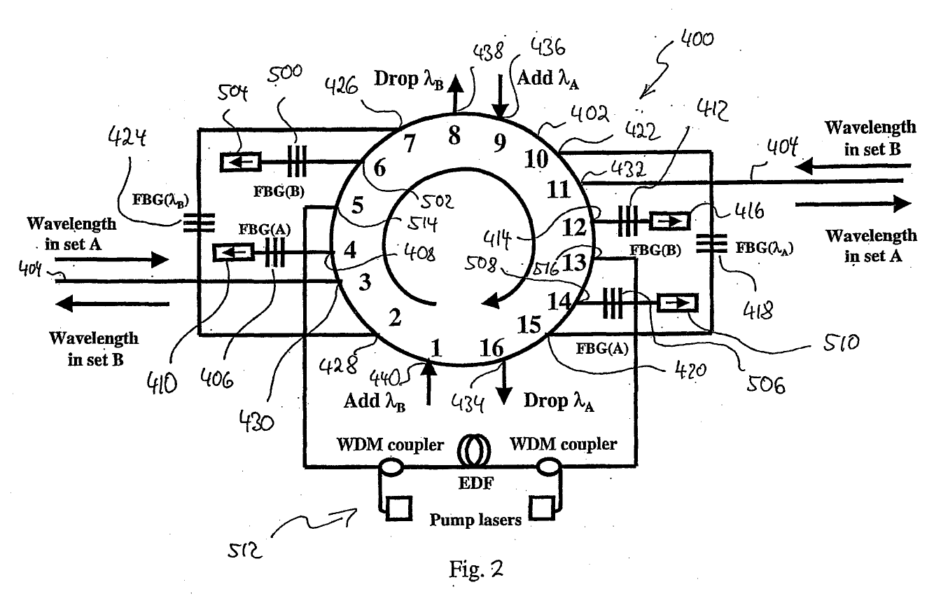

FIG. 2 shows a bi-directional optical add/drop structure 400, with amplification embodying the present invention. The add/drop structure 400 comprises a 16 port MOC 402 connected in line with a bi-directional single fibre connection 404. A fibre Bragg grating 406 is connected to port 408 of the MOC 402 in series with an optical isolator 410. Another fibre Bragg grating 412 is connected to port 414 of MOC 402 in series with another optical isolator 416.

Yet another fibre Bragg grating 418 is connected in series between ports 420 and 422 of MOC 402, and a further fibre Bragg grating 424 is connected in series between ports 426 and 428 of MOC 402.

A further fibre grating 500 is connected to port 502 of MOC 402, in series with another optical isolator 504. Yet a further fibre Bragg grating 506 is connected to port 508 of MOC 402 in series with optical isolator 510.

A bi-directional optical signal is travelling along the single-fibre connection 404, with certain wavelengths in a set of wavelengths A and wavelengths in a set of wavelengths B travelling in opposing directions. In the following, it will be described how optical signals travel through the bi-directional add/drop amplifier structure 400 in each direction.

An optical signal entering the MOC 402 at port 430 is initially filtered at fibre Bragg grating 406. The fibre Bragg grating 406 is designed such that only the particular wavelengths intended for propagation in that propagation direction are reflected back into the MOC 402, whilst unwanted signal is transmitted. Re-entering of the transmitted signal as a result of e.g. reflection events is inhibited by isolator 410.

The filtered signal then exits at port 514 and is amplified in a bi-directional optical amplifier structure 512 connected between ports 514 and 516 of the MOC 402. The amplified signal re-enters the MOC 402 at port 516.

The amplified signal is then filtered again at the fibre Bragg grating 506 to remove unwanted optical signal, such as out-of-band amplified spontaneous emission noise. Re-entering of the removed signal as a result of e.g. reflection events is inhibited by isolator 510.

The reflected (desired) signal is next filtered at the fibre Bragg grating 418. Light that is not reflected at the fibre Bragg grating 418 re-enters the MOC 402 at port 422 and exits at port 432 for continued propagation along the bi-directional single-fibre connection 404.

A particular wavelength that is being reflected at the fibre Bragg grating 418 depending on the design of that fibre Bragg grating 418 re-enters the MOC 402 at port 420 and subsequently exits at port 434. In other words, that particular wavelength is dropped from the optical signal.

At the same time, an optical signal of the same wavelength(s) that is/are dropped at port 434 may enter at port 436 of MOC 402. That signal will exit at port 422, however, it will be reflected by the fibre Bragg grating 418 designed for that particular wavelength(s) (see above), thus re-entering MOC 402 at port 422. Effectively, the additional signal is thus added to the optical signal and exits the MOC 402 through port 432 for continued propagation along the bi-directional single-fibre connection 404.

Similarly, an optical signal entering the MOC 402 at port 432 is filtered at fibre Bragg grating 412 designed to reflect only the particular wavelengths intended for propagation in that particular direction. Unwanted optical signals are transmitted and re-entering into the MOC 402 as a result of e.g. reflection events is inhibited by isolator 416.

The filtered signal exits at port 516 and is amplified in the bi-directional amplifier structure 512 before re-entering MOC 402 at port 514. The amplified signal is then filtered at fibre Bragg grating 500 and unwanted signal such as out-of-band amplified spontaneous emission noise is removed. Re-entering of the unwanted optical signal into the MOC 402 as a result of e.g. reflection events is inhibited by isolator 504.

The reflected amplified signal is next filtered at fibre Bragg grating 424. The portion of the signal that is not reflected at the fibre Bragg grating 424 re-enters the MOC 402 a port 428 and exits at port 430 for continued propagation along the bi-directional single-fibre connection 304.

At the same time, a portion of the optical signal i.e. a particular wavelength reflected by the fibre Bragg grating 424 re-enters the MOC 402 at port 426 and subsequently exits at port 438. Thus, that particular wavelength has been dropped from the optical signal.

An optical signal of the same wavelength(s) may enter the MOC 402 at port 440. That signal exits at port 428 but is reflected at fibre Bragg grating 424, which has been designed at that particular wavelength(s) which are dropped at port 438 (see above). The reflected signal thus re-enters at port 428 and is effectively combined with the remainder of the optical signal which is transmitted through the fibre Bragg grating 424, and exits the MOC 402 at port 430 for continued propagation along the bi-directional single-fibre connection 404.

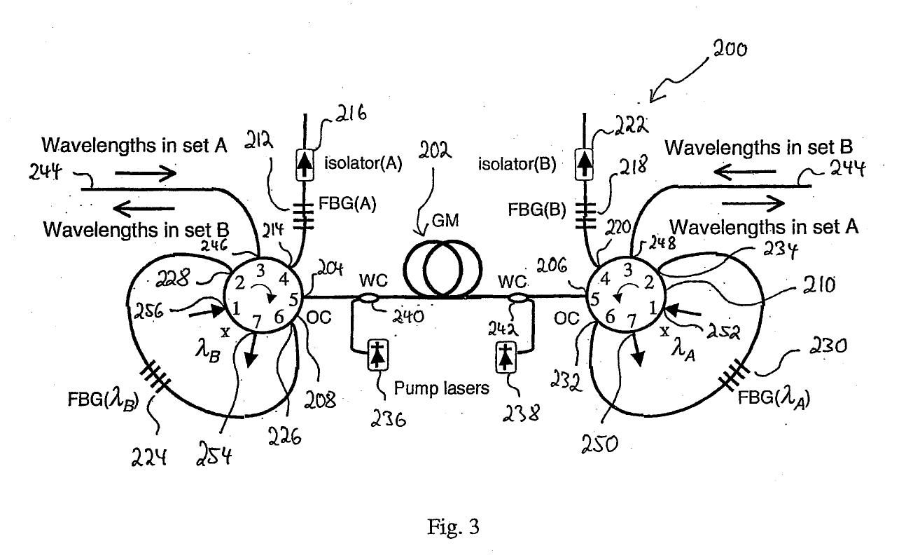

Turning now to FIG. 3, in a bi-directional add/drop structure 200, with amplification, embodying the present invention, a gain medium in the form of an Erbium doped fibre 202 is connected between ports 204, 206 of two MOCs 208, 210 respectively. Two pump lasers 236, 238 are coupled to the Erbium doped fibre 202 by way of wavelength couplers 240, 242 respectively.

A fibre Bragg grating 212 is connected to port 214 of the MOC 208 in series with an optical isolator 216. Similarly, another fibre Bragg grating 218 is connected to port 220 of MOC 210 in series with an optical isolator 222.

A further fibre Bragg grating 224 is connected in series between ports 226 and 228 of MOC 208. Another fibre Bragg grating 230 is also connected in series between ports 232 and 234 of MOC 210.

A bi-directional optical signal is travelling along the single-fibre connection 244, with certain wavelengths in a set of wavelengths A and certain wavelengths in a set of wavelengths B travelling in opposing directions. In the following, it will be described how optical signals travel through the bi-directional add/drop amplifier structure 200 in each direction.

An optical signal entering the MOC 208 at port 246 is firstly filtered at fibre Bragg grating 212. The fibre Bragg grating 212 is designed such that only the particular wavelengths intended for propagation in that propagation direction are reflected back into the MOC 208, whilst unwanted signal is transmitted. Re-entering of the transmitted signal as a result of e.g. reflection events is inhibited by isolator 216.

The filtered signal exits at port 204 and is then amplified in the Erbium doped fibre 202 prior to entering MOC 210 at port 206. The amplified signal then exits at port 232 and is filtered at the fibre Bragg grating 230. Light that is not reflected at the fibre Bragg grating 230 re-enters the MOC 210 at port 234 and exits at port 248 for continued propagation along the bi-directional single-fibre connection 244.

A particular wavelength that is being reflected at the fibre Bragg grating 230 depending on the design of that fibre Bragg grating 230 re-enters the MOC 210 at port 232 and subsequently exits at port 250. In other words, that particular wavelength is dropped from the amplified signal.

At the same time, an optical signal of the same wavelength(s) that is/are dropped at port 250 may enter at port 252 of MOC 210. That signal will exit at port 234, however, it will be reflected by the fibre Bragg grating 230 designed for that particular wavelength(s) (see above), thus re-entering MOC 210 at port 234. Effectively, the additional signal is thus added to the amplified optical signal and exits the MOC 210 through port 248 for further propagation along the bi-directional single-fibre connection 244.

Similarly, an optical signal entering MOC 210 at port 248 is filtered at fibre Bragg grating 218 designed to reflect only the particular wavelengths intended for propagation in that particular direction. Unwanted optical signals are transmitted and their re-entering into the MOC 210 as a result of reflection events is inhibited by isolator 222.

The filtered signal exits at port 206 and is then amplified in the Erbium doped fibre 202 prior to entering MOC 208 at port 204. The amplified signal exits at port 226 and is filtered at fibre Bragg grating 224. The portion of the amplified signal that is not reflected at the fibre Bragg grating 224 re-enters the MOC 208 at port 228 and exits at port 246 for continued propagation along the bi-directional single-fibre connection 244.

At the same time, a portion of the amplified signal i.e. a particular wavelength reflected by the fibre Bragg grating 224 re-enters the MOC 208 at port 226 and subsequently exits at port 254. Thus, that particular wavelength has been dropped from the amplified signal. An optical signal of the same wavelength(s) may enter the MOC 208 at port 256. That signal exits at port 228 but is reflected at fibre Bragg grating 224, which has been designed to reflect at that particular wavelength(s) which are dropped at port 254 (see above). The reflected signal thus re-enters at port 228 and is effectively combined with the remainder of the amplified optical signal which is transmitted through the fibre Bragg grating 224, and exits the MOC 208 at port 246 for continued propagation along the bi-directional single-fibre connection 244.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. An optical drop structure comprising:
a multi-port optical circulator (MOC);
a first reflection filter unit optically connected in series between a first port and a second port of the MOC,
a second reflection filter unit optically connected in series between a third port and a fourth port of the MOC,
and the optical drop structure is arranged, in use, in a manner such that:
a first optical signal entering through a fifth port of the MOC is subjected to the first reflection filter unit and exits at a sixth port of the MOC and a reflected portion of the first optical signal exits at a seventh port of the MOC, and
a second optical signal entering through the sixth port of the MOC is subjected to the second reflection filter unit and exits at the fifth port of the MOC and a reflected portion of the second optical signal exits at an eights port of the MOC.

2. An optical drop structure as claimed in claim 1, wherein the optical drop structure is arranged, in use, in a manner such that a third optical signal entering at an ninth port of the MOC is added to the first optical signal prior to the first optical signal exiting the MOC, and such that a fourth optical signal entering at a tenth port of the MOC is added to the second optical signal prior to the second optical signal exiting the MOC.

3. An optical drop structure as claimed in claim 2, wherein the optical drop structure is arranged, in use, such that the third and fourth optical signals are reflected at the first and the second reflection filter units respectively for being added to the first and second optical signals respectively.

4. An optical drop structure as claimed in claim 1, wherein the optical drop structure further comprises:
third and fourth reflection filter units optically connected to an eleventh port and a twelfth port of the MOC respectively, and
wherein the optical drop structure is arranged, in use, in a manner such that:
the first optical signal is filtered at the third reflection filter unit prior to exiting the MOC, and
the second optical signal is filtered at the fourth reflection filter unit prior to exiting the MOC.

5. An optical drop structure as claimed in claim 1, wherein the optical drop structure further comprises a bi-directional amplifier structure disposed in series between a thirteenth port and a fourteenth port of the MOC, and the optical drop structure is arranged, in use, in a manner such that the first and second optical signals are amplified in a bi-directional amplifier structure prior to exiting the MOC.

6. An optical drop structure as claimed in claim 5, wherein the amplifier unit comprises a gain medium or a semiconductor amplifier or a Raman amplifier.

7. An optical drop structure as claimed in claim 6, wherein, where the amplifier unit comprises a gain medium, the amplifier structure comprises at least one pump laser coupled to the gain medium.

8. An optical drop structure as claimed in claim 7, wherein the pump laser is coupled to the gain medium via a wavelength coupler.

9. An optical drop structure as claimed in claim 6, wherein the gain medium comprises an active optical fibre or an active planar waveguide.

10. An optical drop structure as claimed in claim 9, wherein the active optical fibre comprises Erbium-doped fibre or rare earth doped fibre.

11. An optical drop structure as claimed in claim 5, wherein the optical drop structure is arranged, in use, in a manner such that the first and second optical signals are amplified prior to or after being subjected to the first and second reflection filter units respectively.

12. An optical drop structure as claimed in claim 5, wherein the optical drop structure is arranged, in use, in a manner such that the first and second optical signals are filtered at the third and fourth reflection filter units prior to being subjected to the first and second reflection filter units respectively.

13. An optical drop structure as claimed in claim 12, wherein the optical drop structure further comprises:
fifth and sixth reflection filter units optically connected to a fifteenth port and a sixteenth port of the MOC respectively, and
wherein the optical drop structure is arranged, in use, in a manner such that the first and second amplified signals are filtered at the fifth and sixth reflection filter units respectively, prior to exiting the MOC.

14. An optical drop structure as claimed in claim 1, wherein the optical structure is implemented with two MOCs interconnected in series.

15. An optical drop structure as claimed in claim 14, wherein the two MOCs have opposite circulation directions.

16. An optical drop structure as claimed in claim 1, wherein any one or all of the reflection filter units comprises a fibre Bragg grating structure or a Fabry-Perot filter.

17. An optical add structure comprising:
a multi-port optical circulator (MOC);
a first reflection filter unit optically connected in series between a first port and a second port of the MOC,
a second reflection filter unit optically connected in series between a third port and a fourth port of the MOC,
and the optical add/drop structure is arranged, in use, in a manner such that:
a first optical signal entering through a fifth port of the MOC is subjected to the first reflection filter unit and exits at a sixth port of the MOC,
a second optical signal entering through the sixth port of the MOC is subjected to the second reflection filter unit and exits at the fifth port of the MOC,
a third optical signal entering at a seventh port of the MOC is reflected at the first reflection filter unit and exits at the sixth port of the MOC for adding to the first optical signal, and
a fourth optical signal entering at an eighth port of the MOC is reflected at the second reflection filter unit and exits at the fifth port of the MOC for adding to the second optical signal.

18. A method of adding/dropping signal portions from a bi-directional optical transmission path, the method comprising:
utilising at least one MOC to distinguish between first and second optical signals having opposite transmission directions on the transmission path,
subjecting the first and second optical signals to first and second filtering units for adding/dropping said signal portions in a uni-directional mode, and
utilising said at least one MOC to direct the first and second signal portions for continued propagation along the transmission path in their respective transmission directions.
